(19) United States
(12) Patent Application Publication
(10) Pub. No.: US 2025/0028516 A1
(43) Pub. Date: Jan. 23, 2025

(54) TAILORED RECOMMENDATION OF SOFTWARE UPDATES TO NETWORK ELEMENTS

(71) Applicant: Palo Alto Networks, Inc., Santa Clara, CA (US)

(72) Inventors: Ali Parandehgheibi, Menlo Park, CA (US); Gaurav Sharma, Mountain View, CA (US); Gang Liu, Cupertino, CA (US); Charanraj Thimmisetty, Dublin, CA (US); Alina Asish Rath, San Francisco, CA (US); Suresh Venkataraman, Tracy, CA (US)

(21) Appl. No.: 18/353,348

(22) Filed: Jul. 17, 2023

(51) Int. Cl. G06F 8/65; G06F 8/73; H04L 67/00

(52) U.S. Cl. CPC G06F 8/65; G06F 8/73; H04L 67/34

(57) ABSTRACT

A service analyzes impact of new software updates for various network elements and performs tailored recommendation of software updates to a customer having a network element(s) deployed. The service analyzes impact of a software update based on evaluation of documentation published for the update and data of issues that are at least potentially associated with the software update (e.g., software bugs, vulnerabilities, etc.) to obtain software update metadata and data indicating changes in functionality and/or potential issues affecting the software. The service parses configuration data for the network element(s) based on the update impact data/metadata to extract a subset that is relevant to available software updates. The service evaluates the update impact data/metadata and the extracted configuration data based on heuristics to determine which of the software updates to recommend for each network element and recommends those that suit the use of the network element based on its current configuration while introducing minimal issues.

### BACKGROUND

The disclosure generally relates to arrangements for software engineering (e.g., CPC subclass G06F 8/00) and to updates (e.g., CPC subclass G06F 8/65).

Some hardware devices have software installed thereon to facilitate their operation. Software installed on a hardware device can include operating system software and/or application software. Other devices may be implemented with software that runs on a general-purpose computer system. An example of a device that can be implemented with hardware having software installed thereon or with software is a firewall. Firewalls and other devices having software installed thereon can be equipped with a plurality of configurable settings by which functionality can be enabled, disabled, or otherwise configured.

### BRIEF DESCRIPTION OF THE DRAWINGS

Embodiments of the disclosure may be better understood by referencing the accompanying drawings.

FIG. 1 is a conceptual diagram of tailoring recommendation of software updates to a customer's security network element(s).

FIG. 2 is a conceptual diagram of correlating issues associated with a software update with features offered by the software update to determine configurable settings to which the issues pertain.

FIG. 3 is a flowchart of example operations for processing published software documentation to obtain data/metadata of software updates that inform recommendations.

FIG. 4 is a flowchart of example operations for correlating issues affecting a software update for a network element(s) with the most relevant configurable setting of the network element(s).

FIG. 5 is a flowchart of example operations for determining one or more software updates to recommend for a network element based on its current configuration.

FIG. 6 is a flowchart of example operations for heuristically analyzing data/metadata of a software update based on extracted configuration data of a network element to inform software update recommendations for the network element.

FIG. 7 depicts an example computer system with a tailored software update recommendation service and a software update and issue analyzer.

### DESCRIPTION

The description that follows includes example systems, methods, techniques, and program flows to aid in understanding the disclosure and not to limit claim scope. Well-known instruction instances, protocols, structures, and techniques have not been shown in detail for conciseness.

### Terminology

Use of the phrase “at least one of” preceding a list with the conjunction “and” should not be treated as an exclusive list and should not be construed as a list of categories with one item from each category, unless specifically stated otherwise. A clause that recites “at least one of A, B, and C” can be infringed with only one of the listed items, multiple of the listed items, and one or more of the items in the list and another item not listed.

### Overview

The task of determining a software update to adopt for an existing network element (e.g., a firewall) has typically been a manual undertaking by customers, which may be avoided due to concerns of operational overhead, disruption of expected functionality and performance, or exposure to new vulnerabilities or security issues resulting from upgrading, among other reasons. Additionally, manual update analysis can be laborious and time consuming due to the plethora of new features, bug fixes, and behavior changes introduced by available update versions. Disclosed herein are techniques for automated, customized recommendation of software updates to a customer that allows for customers to obtain software update recommendations that are tailored to the customer's network element usage on-demand.

An update analysis and recommendation service analyzes impact of new software updates as they become available for various network elements and performs tailored recommendation of software updates to a customer having one or more network elements deployed. The service analyzes impact of a software update based on evaluation of documentation published for the update and data of issues that are at least potentially associated with the software update, such as data indicating software bugs, known vulnerabilities of the software update, and support tickets submitted by other customers. The evaluation of published documentation and issues yields software update metadata and data that indicates the offered features that have changed with the update and/or may be affected by a bug or other issue as well as any pertinent vulnerabilities. The service obtains configuration data for each of one or more network elements deployed by the customer and parses the configuration data to extract a subset that is relevant to software updates that are available for the network element(s). The relevant subset of configuration data to extract is informed by the update data/metadata. To exemplify, a feature indicated in the configuration data for a network element that is not affected by any software updates available to the network element may not be extracted from the configuration data, while a feature indicated in the configuration data that has associated data/metadata indicative of a change in behavior, a potential bug, or other indication that a software update will impact the feature will be extracted.

To generate a recommendation comprising one or more software updates for the customer's network element(s), the service evaluates the update data/metadata and the extracted configuration data based on heuristics to determine which of the software updates suit the customer's use of the network element(s) while introducing minimal issues. Which of the software updates to recommend is informed by the heuristics, which can comprise heuristics for determining likelihood of issues impacting a software update, severity of issues, and relevance of issues based on the available update data/metadata and extracted configuration data. With the recommendation, the service can further indicate issues that are avoided with each recommended update, such as vulnerabilities and/or bugs present in a prior release (e.g., the software version currently running on the network element). The result is a comprehensive, multi-dimensional recommendation from which the customer can make an informed decision for selecting software updates to install.

### Example Illustrations

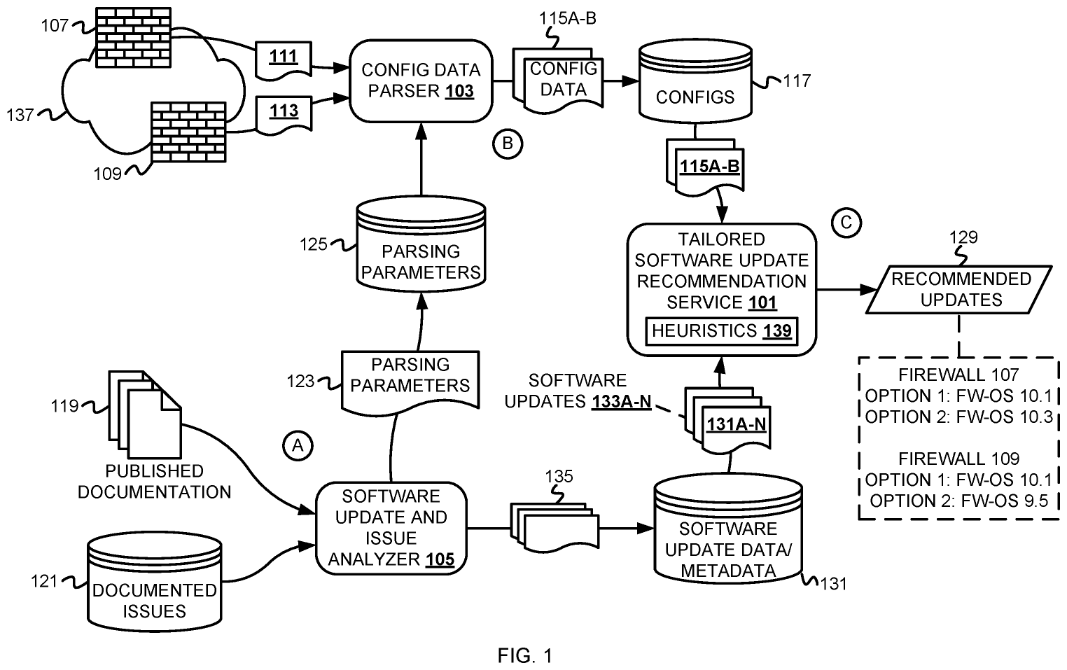

FIG. 1 is a conceptual diagram of tailoring recommendation of software updates to a customer's security network element(s). A firewall 107 and a firewall 109 have been instantiated in a customer's network(s) 137. The firewall 107 and firewall 109 can be physical firewalls and/or virtual (e.g., cloud-based) firewalls. The firewall 107 and the firewall 109 may be different types (e.g., models) of firewalls. The customer refers to the entity (e.g., enterprise/organization) having an account(s) with a provider of the firewall 107 and the firewall 109 (e.g., a security organization that offers or makes available the firewall 107 and firewall 109). The provider of the firewall 107 and the firewall 109 (collectively “the firewalls 107, 109) is referred to below as “the vendor.” FIG. 1 also depicts a tailored software update recommendation service 101, a configuration data parser 103, and a software update and issue analyzer 105 (hereinafter “the recommendation service 101,” “the parser 103,” and “the analyzer 105,” respectively). The recommendation service 101, the parser 103, and the analyzer 105 can execute on the same server or on different respective servers, which may be physical and/or virtual (e.g., cloud) servers.

FIG. 1 is annotated with a series of letters A-C, each of which represents one or more operations. Although these stages are ordered for this example, the stages illustrate one example to aid in understanding this disclosure and should not be used to limit the claims. Subject matter falling within the scope of the claims can vary from what is illustrated.

At stage A, the analyzer 105 analyzes software update documentation published by the vendor and data documented issues that may affect the software updates. Analysis of software update documentation and issues serves two purposes: 1) to determine parsing parameters to be stored in a repository 125 that is accessible to the parser 103, and 2) to determine software update data/metadata to be stored in a repository 131 that is accessible to the recommendation service 101 for informing recommendations. The vendor has made available published documentation 119 for one or more software updates. Those of the published documentation 119 for each software update can include software release notes, administrator guides, etc. The analyzer 105 analyzes the published documentation 119 for each of the software updates to determine type (e.g., operating system) and version number of the software update and any changes that may result from installation of the software update (e.g., new features made available with the software update and/or existing features for which behavior is changed with the software update). A “feature” refers to a configurable setting of a network element and is generally described in documentation of a software update in terms of the added or modified functionality (for new and existing features, respectively) it offers. The analyzer 105 may also determine issues that are fixed by the software update that were present in prior releases based on indications of such in the published documentation 119. The analyzer 105 also correlates the published documentation 119 with data of documented issues obtained from at least a first repository 121. The repository 121 can encompass a data store for documentation of software bugs and/or a data store for support tickets submitted to the vendor that is/are accessible to the analyzer 105 (e.g., via an application programming interface (API) of the repository).

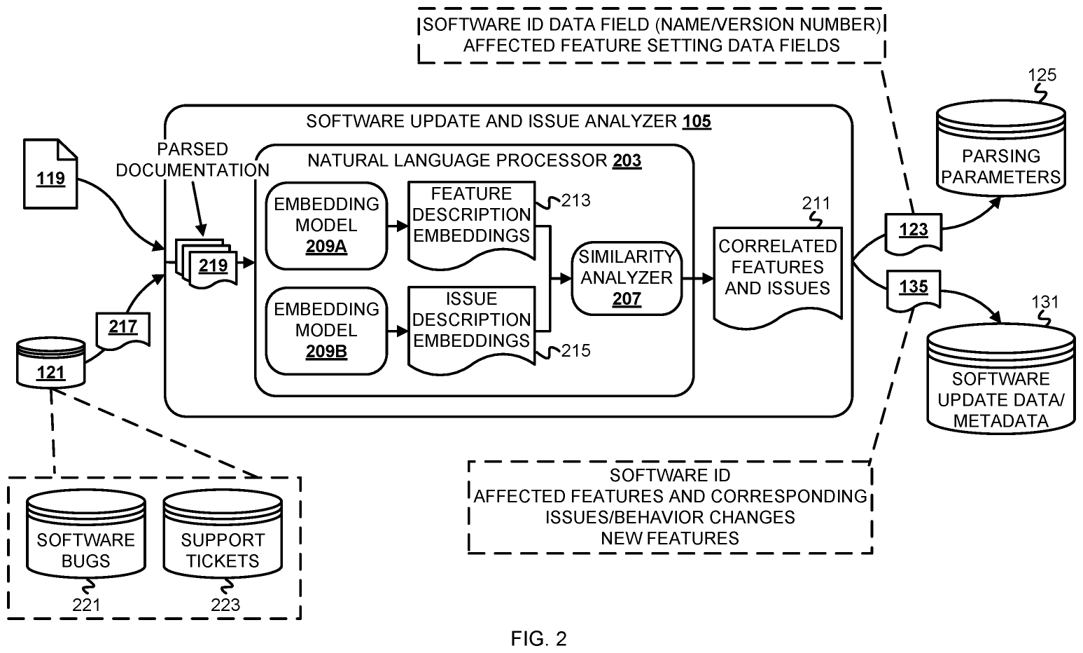

The analyzer 105 generates parsing parameters 123 and software update data/metadata 135 based on the analysis and correlation. The parsing parameters identified in the repository 125 comprise indications of configuration data fields corresponding to features of network elements that are potentially affected by each of the software updates identified in the published documentation 119, such as based on having a documented change in behavior identified in the published documentation 119 and/or being correlated with an issue documented in the repository 121. The analyzer 105 inserts the parsing parameters 123 into the repository 125 for subsequent access by the parser 103. Those of the software update data/metadata 135 corresponding to each software update can include the new features provided by the software update, existing features affected by changes in behavior with the software update (e.g., a change in default configuration), issues that may affect the software update, issues fixed via the software update, etc. The analyzer 105 inserts the software update data/metadata 135 into the repository 131 for subsequent access by the recommendation service 101. Analysis and correlation of published documentation of software updates and documented issues by the analyzer 105 for generation of the parsing parameters 123 and the software update data/metadata 135 is described in further detail in reference to FIG. 2.

At stage B, the parser 103 parses configuration data obtained for the firewalls 107, 109 to extract subsets of the configuration data that are relevant to available software updates based on the parsing parameters maintained in the repository 125. Each of the firewalls 107, 109 has device telemetry enabled and transmits a telemetry stream to the parser 103. Telemetry data that the firewalls 107, 109 stream to the parser 103 include configuration data of each respective firewall, which may differ between firewalls. In this example, the firewall 107 streams telemetry data 111 to the parser 103, and the firewall 109 streams telemetry data 113 to the parser 103. The telemetry data 111 indicate configuration data of the firewall 107, such as a type of device to which the firewall 107 corresponds and configured settings of features of the firewall 107 (i.e., enabled and/or disabled settings of various functionality offered by the firewall 107). Similarly, the telemetry data 113 indicate configuration data of the firewall 109, such as a type of device to which the firewall 109 corresponds and configured settings of features of the firewall 109. The parser 103 parses the telemetry data 111 and telemetry data 113 based on the parsing parameters identified in the repository 125 to extract configuration data 115A and configuration data 115B, respectively. The configuration data 115A-B correspond to the configuration data that are considered relevant to software updates made available by the vendor, such as the configuration data that indicate network element type and/or operating system, software version number, features affected by a change in behavior and/or a potential issue (e.g., a bug), for example. The parser 103 stores the configuration data 115A-B in a repository 117 that maintains configuration data obtained from parsing telemetry data streams. The parser 103 can associate an identifier of each of the firewalls 107, 109 with the respective ones of the configuration data 115A-B prior to insertion, such as by labelling, tagging, etc. the configuration data 115A-B with a corresponding firewall identifier determined from each of the telemetry data 111 and 113.

At stage C, the recommendation service 101 generates a recommendation for one or more software updates that are available for installation to each of the firewalls 107, 109 based on analysis of configuration data extracted for the firewalls 107, 109 (i.e., the configuration data 115A-B) and software update data/metadata obtained from the repository 131. Generation of a recommendation is based on satisfaction of a triggering condition, such as based on receipt of a request for a recommendation or based on passage of a designated period of time since a last recommendation or installation of a software update as monitored by the recommendation service 101. This example assumes that a triggering condition has been satisfied for the firewalls 107, 109, based on which the recommendation service 101 retrieves the configuration data 115A-B from the repository 117.

The recommendation service 101 evaluates each of the configuration data 115A-B to determine one or more software updates that are available for the corresponding one of the firewalls 107, 109. A software update is available for a network element (i.e., one of the firewalls 107, 109 in this example) if it is compatible with the network element and is of a later version than that currently installed on the network element. The recommendation service 101 may maintain or have access to network element compatibility data for each software update that the analyzer 105 has processed. The recommendation service 101 determines the software currently running on each of the firewalls 107, 109 based on the respective configuration data 115A-B, generates a query for each of the firewalls 107, 109 that indicates the compatible software updates, and submits the queries to the repository 131 to obtain the corresponding data/metadata of the available software updates. In response to the queries, the recommendation service 101 obtains software update data/metadata 131A-N corresponding to software updates 133A-N that are available for respective ones of the firewalls 107, 109.

For each of the software updates 133A-N and respective one of the firewalls 107, 109 and configuration data 115A-B, the recommendation service 101 evaluates configuration of settings identified in the configuration data 115A-B and the indications of issues in the software update data/metadata to determine how installation of the software update may affect operation or configuration of the firewall. The recommendation service 101 determines the features (i.e., a configurable setting) that are enabled for each of the firewalls 107, 109 based on settings identified in the respective ones of the configuration data 115A-B. For each of the software updates 133A-N and corresponding one of the firewalls 107, 109, the recommendation service can then correlate the enabled features of the firewall with the issues indicated in the respective ones of the software update data/metadata 131A-N to determine which of the issues, if any, are relevant to the firewall based on the issues potentially affecting enabled functionality of the firewall. Assuming that each of the software updates 133A-N has at least one relevant issue identified, this yields a set of one or more issues for each of the software updates 133A-N that are relevant to the corresponding one of the firewalls 107, 109. This at least includes issue name and/or description (e.g., software bug name/description). Each set of issues may further indicate issue type, issue severity, and/or a frequency of reports or case counts associated with that issue for other customers.

The recommendation service 101 has been configured with heuristics 139 for determining which of the software updates 133A-N to recommend for installation to the respective one of the firewalls 107, 109. The heuristics 139 comprise heuristics for determining the impact of installing a software update to a network element, such as based on the issues associated with the software update, frequency with which those issues are experienced and/or likelihood of the issues, severity of the issues, and the like. The heuristics 139 may be implemented with rules and/or thresholds based on which the sets of issues determined for each of the available software updates 133A-N and respective one of the firewalls 107, 109 are evaluated. For instance, with reference to the firewall 107 and corresponding ones of the software updates 133A-N, the recommendation service 101 analyzes the set of issues of each of the software update available to the firewall 107 based on the heuristics 139. The recommendation service 101 may further score each software update based on the analysis that is based on the heuristics 139. For instance, the recommendation service 101 may compute a score for each software update that accounts for the number of issues, the severity of the issues, and/or the frequency/likelihood of the issues (e.g., based on the frequency of reports or case counts). The resulting score in this case indicates a potential impact that installing the software update would have on performance or operation of the firewall 107.

The recommendation service 101 generates and indicates a recommendation 129 indicating recommended software updates for each of the firewalls 107, 109. The selection of which of the software updates 133A-N to recommend for each respective one of the firewalls 107, 109 is based on the heuristic analysis of the software update data/metadata 131A-N that is guided by the configuration data 115A-B. For instance, in the case where the recommendation service 101 scores each of the software updates 133A-N, the recommendation service 101 can select the software update(s) available to each of the firewalls 107, 109 having the best score. A best score may be the highest or lowest score depending on scoring mechanism that is implemented. In this example, the recommendation service 101 selected two software updates to recommend for each of the firewalls 107, 109.

For the firewall 107, the recommendation 129 indicates a software update referred to as “FW-OS 10.1” as a first option and a software update referred to as “FW-OS 10.3” as a second option. These updates may have been determined to have minimal and/or lower frequencies of issues affecting features that are enabled for the firewall 107. As another illustrative example, the software update referred to as “FW-OS 10.3” may include a fix for a vulnerability or other major (e.g., high frequency) issues identified in a preceding version that is thus not recommended. For the firewall 109, the recommendation 129 indicates a software update “FW-OS 10.1” as a first option and a software update referred to as “FW-OS 9.5” as a second option. For the firewall 109, the software update “FW-OS 9.5” may have had fewer and/or lower impact issues that are relevant to the configuration of the firewall 109 in comparison to the software update “FW-OS 10.3.” The recommendation 129 that the recommendation system 101 generates thus accounts for the actual configuration and use of each of the firewall 107, 109. While not depicted in FIG. 1 for clarity, the recommendation 129 can also indicate those of the software update data/metadata 131A-N corresponding to the software updates “FW-OS 9.5,” “FW-OS 10.1,” and “FW-OS 10.3,” such as the new features and changes in existing features (e.g., changes in default configuration) associated with each software update, issues associated with each software update and the corresponding impact of the issue with respect to the appliance, such as in terms of the feature of the appliance that the issue affects, counts of cases reported for each issue, etc.

While depicted as a series of stages in FIG. 1 for ease of illustration and to aid in understanding, the corresponding operations do not necessarily occur sequentially. Generation of parsing parameters and software update data/metadata by the analyzer 105 may be periodic as new software updates to appliances become available and/or as new issues associated with software updates offered by the vendor are discovered. Parsing of configuration data by the parser 103 based on parsing parameters maintained in the repository 125 may be ongoing as network elements such as the firewalls 107, 109 stream telemetry data to the parser 103 or may be triggered based on otherwise receiving configuration files of network elements (e.g., based on upload by a customer or download from a repository, etc.). Generation of recommendations by the recommendation service 101 is based on a triggering condition being satisfied, such as based on receipt of a request from a customer or based on passage of a designated length of time since a last software update by the customer.

FIG. 2 is a conceptual diagram of correlating issues associated with a software update with features offered by the software update to determine configurable settings to which the issues pertain. FIG. 2 depicts the analyzer 105 obtaining the published documentation 119 of at least a first software update and issue data/metadata 217 from the repository 121 of FIG. 1. FIG. 2 depicts the repository 121 as encompassing a repository 221 that stores documented software bugs and a repository 223 that stores support tickets submitted to a vendor. “The repository 121” can refer to either of the repositories 221, 223 in this example, as data indicating issues associated with a software update can originate from a plurality of different sources. Additionally, though not depicted in this example, different repositories for documenting other types of issues may be utilized (e.g., a vulnerability database). While the published documentation 119 can comprise documentation of a plurality of software updates, for clarity and to aid in understanding, “the published documentation 119” as used in FIG. 2 refers to the published documentation obtained for one software update.

The analyzer 105 preprocesses the published documentation 119 to generate preprocessed documentation 219. The published documentation 119 are preprocessed at least to generate a plurality of documents for natural language processing, where each of the plurality of documents corresponds to a feature identifier/name and a description of that feature included in the published documentation 119. Various text preprocessing techniques can be used to transform the published documentation 119 into the plurality of documents represented by the preprocessed documentation 219. Preprocessing of the published documentation 119 may be based on a known format of the published documentation 119 and the information included therein. As an example, features and their descriptions may be included in the published documentation 119 in tabular format. The analyzer 105 can generate the preprocessed documentation 219 from this format based on parsing the text stored in the table and generating corresponding documents that associate each feature name/identifier and description.

The analyzer 105 comprises a natural language processor 203. The natural language processor 203 may perform additional preprocessing of the preprocessed documentation 219 depending on the natural language processing technique(s) being applied (e.g., natural language processing model type(s)). The natural language processor 203 includes an embedding model 209A and an embedding model 209B. The embedding model 209A has been trained to generate feature description embeddings 213 based on textual descriptions of features identified from the preprocessed documentation 219. The embedding model 209B has been trained to generate issue description embeddings 215 based on textual descriptions of issues identified in the issue data/metadata 217. The embedding models 209A-B may be off-the-shelf embedding models, such as doc2vec models, trained respectively on text descriptions of features of network elements (e.g., security features) extracted from published documentation of software and on text descriptions of issues (e.g., software bugs) documented for various software.

A similarity analyzer 207 of the natural language processor 203 determines similarities between each of the issue description embeddings 215 and the feature description embeddings 213. Determining similarity of an issue description with a feature description provides for inference of which configurable setting made available by software running on a network element is most likely relevant to an issue. The similarity analyzer 207 can determine similarity (e.g., semantic similarity) between each of the issue description embeddings 215 and each feature description embedding in the set of feature description embeddings 213 to retrieve a plurality of similarity scores for each of the issue description embeddings. The similarity analyzer 207 can determine the N feature description embeddings exhibiting the highest similarity with each issue description embedding. From this set of N feature descriptions, the similarity analyzer 207 may determine the most similar feature to each issue, such as by determining the feature with the greatest similarity that satisfies a threshold. Expert knowledge may further be employed to analyze the N most similar features for each issue and select the one determined to be most similar. The natural language processor 203 generates correlated features and issues 211 that comprise indications of issues documented for the software update and the corresponding feature(s) determined to be most relevant to each issue.

As part of correlating issues and features, the analyzer 105 can also determine frequency of the issues based on support tickets designating the software update that are obtained from the repository 223. Each issue listed in a support ticket may be identified with a description and/or issue identifier, such as an identifier of a software bug assigned by the vendor. The analyzer 105 can retrieve support tickets (if any) that identify the software update from the repository 223 and, for each of the retrieved support tickets, determines an issue(s) designated therein for which the support ticket was submitted, such as based on a known format of support tickets of the vendor, and determine the counts corresponding to each issue accordingly. As another example, the analyzer 105 can query the repository 121 for support tickets submitted for each issue identified in the correlated features and issues 211 and determine counts associated with the results of each query. The analyzer 105 can then associate with each of the correlated features and issues 211 a number of reports identified in the support tickets that correspond to the issue.

The analyzer 105 generates at least a subset of the parsing parameters 123 that are inserted into the repository 125 based on the correlated features and issues 211. Each of the generated parsing parameters 123 indicates a field of configuration data that may be obtained from a network element. For each of the correlated features and issues 211, the analyzer 105 determines a corresponding configuration data field having a value indicating a setting of the feature for the associated network element. For instance, the analyzer 105 may determine an XPath expression that corresponds to each configuration data field based on a predetermined format of configuration data/files of the vendor's network elements. In this case, the subset of the parsing parameters 123 corresponding to the correlated features and issues 211 comprise XPath expressions that can be evaluated to determine a setting of the respective feature in the configuration of a network element for which configuration data are obtained. Generating parsing parameters based on the correlated features and issues 211 guides extraction of “relevant” configuration settings from a network element, or those that may be affected by an issue as inferred by the analyzer 105.

The analyzer 105 inserts the software update data/metadata 135 into the repository 131, where the software update data/metadata 135 identify the software update and comprise the correlated features and issues 211. The software update data/metadata can further include indications of features added and/or modified by the software update as described in reference to FIG. 1. The software update data/metadata 135 may be subject to evaluation based on expert knowledge before insertion into the repository 131 to verify and/or supplement the information reflected in the data/metadata 135. Additionally, to supplement the information about a software update represented in the software update data/metadata 135, additional metadata of the software update (e.g., release date, rate of adoptions by customers, etc.) can be inserted in the repository 131, such as by the analyzer 105 based on retrieval of additional information about the software update available thereto or another entity/component with access to the repository 131.

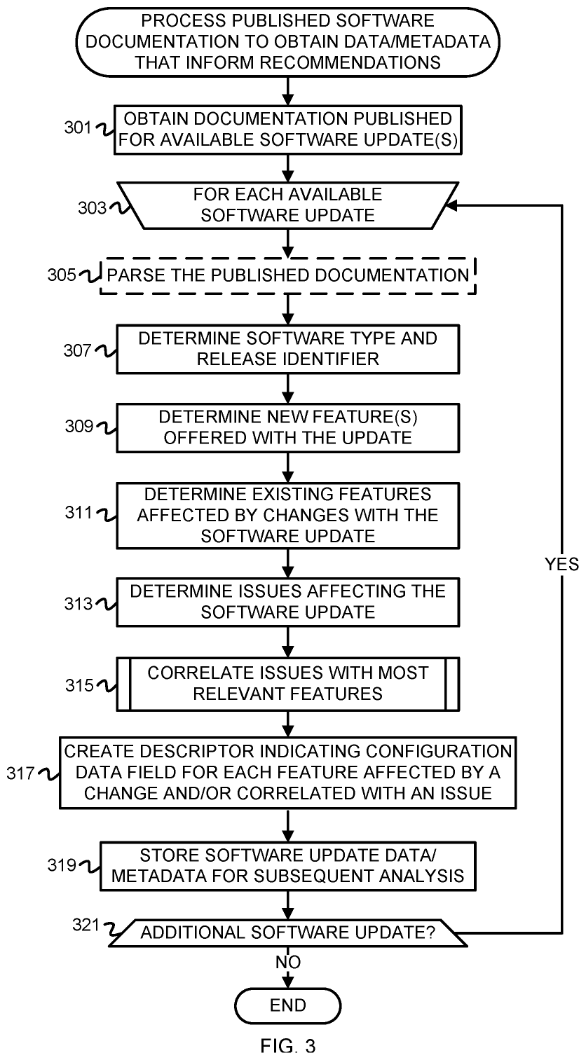

FIGS. 3-6 are flowcharts of example operations. The example operations are described with reference to a software update and issue analyzer (“the analyzer”) and a tailored software update recommendation service (“the recommendation service”) for consistency with the earlier figures and/or ease of understanding. The name chosen for the program code is not to be limiting on the claims. Structure and organization of a program can vary due to platform, programmer/architect preferences, programming language, etc. In addition, names of code units (programs, modules, methods, functions, etc.) can vary for the same reasons and can be arbitrary. The example operations also refer to software updates made available for “network elements” of a vendor. A network element refers to a network element that has software installed and running thereon. Network elements may be physical devices, virtual devices, cloud-based devices, etc. Software updates for the network element are managed by a customer of the vendor to whom the network element has been provisioned.

FIG. 3 is a flowchart of example operations for processing published software documentation to obtain data/metadata of software updates that inform recommendations. The example operations are described with reference to the analyzer. The example operations assume that a vendor has published documentation of at least a first software update available for a network element offered by the vendor. Examples of published documentation include software release notes, admin guides, and wikis, among others.

At block 301, the analyzer obtains documentation that has been published for one or more software updates made available by the vendor. The analyzer can obtain the documentation via an API of the vendor (e.g., an API for accessing a repository of product documentation) and/or based on upload of the documentation to the analyzer. Obtaining software documentation by the analyzer may be triggered by detection that documentation of a new software update has been published. For instance, the analyzer may monitor a repository in which published documentation is stored and retrieve the documentation upon detecting that new documentation has been inserted. The obtained documentation for each of the software updates may be of one or more types.

At block 303, the analyzer begins iterating through the obtained published documentation of each available software update. Documentation metadata may identify the corresponding software update (e.g., by software name and/or version number). The documentation obtained for a software update can encompass one file or multiple files. In the case of the latter, “the published documentation” refers to the collection of files comprising documentation obtained for the software update.

At block 305, the analyzer preprocesses the published documentation. Preprocessing of the published documentation may depend on the format of the published documentation and/or its contents (e.g., based on file type and/or formatting of contents included therein). Preprocessing of the published documentation can include parsing, tokenizing, or other techniques by which the contents of the documentation are made accessible.

At block 307, the analyzer determines a software type and release identifier for the software update. The software type may be represented with a software name (e.g., operating system name). The release identifier may be a version number. The analyzer can determine the software type and release identifier based on searching the preprocessed documentation and/or metadata of the documentation.

At block 309, the analyzer determines one or more new features (if any) offered with the update. The published documentation may indicate functionality that is added with the software update (the “features”) in terms of new settings that can be configured for a network element on which the update is installed. New features may be listed in a section of the documentation, such as by feature name and description. The analyzer can determine the new features and optionally their corresponding descriptions based on a known format of the preprocessed documentation (e.g., if new features and their descriptions are stored in a table), for example. The analyzer may store names/identifiers of each new feature and the corresponding textual description identified from the documentation in a data structure, write the feature names and descriptions to a file (e.g., a text file), etc.

At block 311, the analyzer determines one or more existing features affected by changes with the software update (if any). A software update may be associated with changes in behavior (e.g., changes in default settings/functionality) for one or more existing features. Changes to existing features and descriptions of the changes may be listed in a section of the documentation, such as by feature name and description of the relevant change. The analyzer determines those features and optionally their descriptions based on a known format of the preprocessed documentation, for example. The analyzer may store names/identifiers of each feature associated with a change and the corresponding textual description of the change in a data structure, write each feature name and change description to a file, etc.

At block 313, the analyzer determines one or more issues (if any) affecting the software update. An issue refers to a software bug or other reported issue (e.g., via customer support tickets) documented for the software update. The analyzer has access to one or more repositories in which data/metadata of documented issues are maintained, such as a database maintained by a bug tracking service. The analyzer queries each accessible repository with the software type and/or release identifier to retrieve data and metadata of issues that have been documented for the software update. Each retrieved issue data/metadata at least comprise a description of the issue and may further include a name or identifier of the issue.

In implementations, the analyzer may retrieve an indication of an issue that affects a range of software versions or an indication of a version in which an issue was fixed without a clear indicator of the previous versions affected by the fix. Further, discrepancies between actual software releases affected by issues and software releases that are documented as affected may exist due to software regression and/or backporting that are not reflected in the issue data/metadata. To verify that the software update is affected by the issue, the analyzer can “trace” along software release identifiers (i.e., software name/type and release identifier) indicated in the obtained issue data/metadata to aid a determination of whether the issue does affect the software update or if the issue is pertinent to another software update(s). Tracing along software release identifiers refers to identifying other software release identifiers indicated in the issue data/metadata, such as those indicated in reference to related issues or duplicate issues, and retrieving the corresponding data/metadata documented for those issues in association with the other software release identifiers. Tracing along release identifiers can be further based on the versioning paradigm used by the vendor. For instance, the issue data/metadata may indicate a major release identifier that has several minor releases associated therewith (e.g., a major release with version 10 that encompasses minor versions 10.1-10.N, a release with version 10.1 that encompasses minor versions 10.1.1-10.N.M, etc.). The analyzer may obtain documented issue data/metadata by stepping through each minor release identifier corresponding to the major release, such as in increments of 0.1. The analyzer may store indications of actual impacted software releases for an issue in the event that the analysis yields a finding that a different software release(s) is affected by the issue to facilitate subsequent determination of issues associated with a software update.

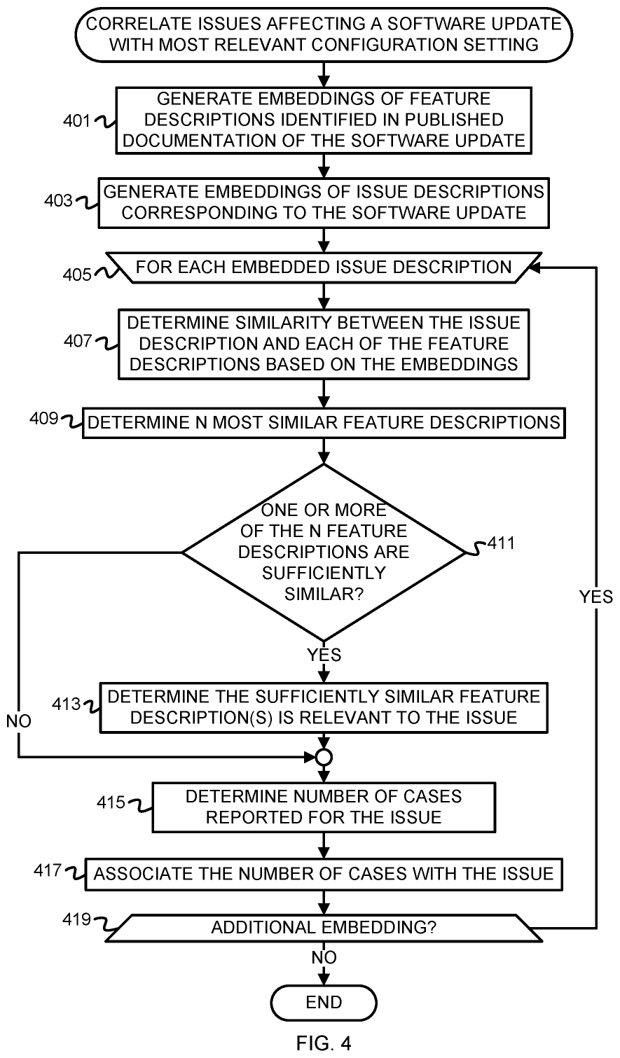

At block 315, the analyzer correlates the issues with the most relevant features associated with the software update. Generally, data/metadata of documented issues will indicate the affected software release but will not specify the particular feature offered by the corresponding software update that is affected by the issue. The analyzer utilizes natural language processing (NLP) to process the descriptions of features both new and existing and the descriptions of issues and determine similarities between the feature and issue descriptions. For each of the issues, the feature that is most similar (optionally subject to a similarity threshold and/or verification based on expert knowledge) is determined to be potentially affected by the issue. Correlation of issues with features yields a set of issues affecting the software update and the most relevant features inferred to be impacted by each issue. Correlation of issues with features is described in further detail in reference to FIG. 4.

At block 317, the analyzer creates a descriptor indicating a configuration data field for each feature that is affected by a change and/or correlated with an issue associated with the software update (i.e., the features determined at blocks 311 and 315, respectively). Each descriptor represents the feature in terms of the corresponding configuration data field that stores a setting of the feature. The descriptors thus facilitate parsing of configuration data to extract a subset of configuration data that is relevant to (i.e., impacted by) the software update. A descriptor may represent a position of or path to the configuration data field based on a known format of configuration data of the vendor's network elements. For instance, a descriptor of a configuration data field may comprise an XPath expression that can be evaluated against the configuration data to determine the value of the field. The descriptors may comprise logical constructs that specify the software type and release identifier to further guide extraction of the corresponding configuration data subject to a network element having installed software of the associated type and version. The analyzer stores the created descriptors in a repository or other data store that can subsequently be accessed and utilized to inform parsing of configuration data obtained for a network element.

At block 319, the analyzer stores software update data and metadata generated based on the published documentation and data of issues associated with the software update for subsequent analysis. The software update data and metadata comprise indications of the new features and the changed features determined at blocks 309 and blocks 311, respectively. The software update data and metadata also comprise the correlated issues and most relevant features determined at block 315. The analyzer associates an indication of the software update (e.g., the software name/type and release identifier) with the software update data/metadata and inserts the software update data/metadata in a repository. The repository may be indexed by software name/type and release identifier.

At block 321, the analyzer determines if there is an additional software update for which published documentation was obtained. If so, operations continue at block 303. Otherwise, operations are complete.

FIG. 4 is a flowchart of example operations for correlating issues affecting a software update for a network element(s) with the most relevant configurable setting of the network element(s). The example operations can implement block 315 of FIG. 3.

At block 401, the analyzer generates embeddings of feature descriptions identified in published documentation of the software update. The feature descriptions comprise textual descriptions of one or more features available with the software update. To generate each of the embeddings, the analyzer can utilize an embedding model that has been trained to generate embeddings based on multi-word descriptions of features/configuration settings (e.g., a trained doc2vec model). The name or other identifier of each feature that was determined based on published documentation of the software update may be maintained as a label, tag, etc. in association with the corresponding embedding.

At block 403, the analyzer generates embeddings of issue descriptions corresponding to the software update. The issue descriptions comprise textual descriptions of one or more software bugs or other software issues that have been documented for the software update. To generate each of the embeddings, the analyzer can utilize an embedding model that has been trained to generate embeddings based on multi-word descriptions of software issues (e.g., a trained doc2vec model). The name or other identifier of each issue may be maintained as a label, tag, etc. in association with the corresponding embedding. At block 405, the analyzer begins iterating over the embedded issue descriptions.

At block 407, the analyzer determines a similarity between the issue description and each of the feature descriptions based on the embeddings. For each of the feature description embeddings, the analyzer computes a similarity (e.g., lexical or semantic similarity) between the feature description and the issue description based on the corresponding embeddings. Computing similarities between the issue description and each feature description based on the embeddings yields a set of similarity values.

At block 409, the analyzer determines the N most similar feature descriptions to the issue description. The value of N may be a preconfigured setting of the analyzer or provided as a parameter value. The analyzer ranks the features by similarity determined based on their descriptions and selects the N features having descriptions with the greatest similarities.

At block 411, the analyzer determines if one or more of the N feature descriptions are sufficiently similar. The analyzer may maintain a threshold based on which it evaluates computed similarities to determine whether any of the most similar feature descriptions are sufficiently similar and thus can be inferred to be related to an issue. If one or more of the N feature descriptions are sufficiently similar (e.g., based on the respective similarity(ies) satisfying the threshold), operations continue at block 413. Otherwise, operations continue at block 415.

At block 413, the analyzer determines that the one or more sufficiently similar feature descriptions are relevant to the issue. The analyzer can generate an association between an indication of the issue (e.g., based on the issue identifier and/or description) and the one or more feature names and descriptions, such as by storing the indication of the issue and the corresponding feature(s) in a data structure.

At block 415, the analyzer determines a number of technical support cases documented for the issue. The analyzer can access technical support tickets created for issues previously reported by customers of the vendor, where each support ticket can identify a particular issue being reported (e.g., with a bug identifier). Counts of reports associated with each issue may have been previously determined or the analyzer can determine the counts of reports associated with the issue based on querying a repository maintaining technical support tickets for those corresponding to the issue and determining a count of the resulting support tickets.

At block 417, the analyzer associates the number of technical support cases with the issue. The analyzer can label, tag, or otherwise associate the number of technical support cases (if any) documented for the issue with the association between the issue and the most relevant feature(s) or with an indication of the issue if no substantially similar features were identified.

At block 419, the analyzer determines if there is an additional issue description embedding. If so, operations continue at block 405. Otherwise, operations are complete.

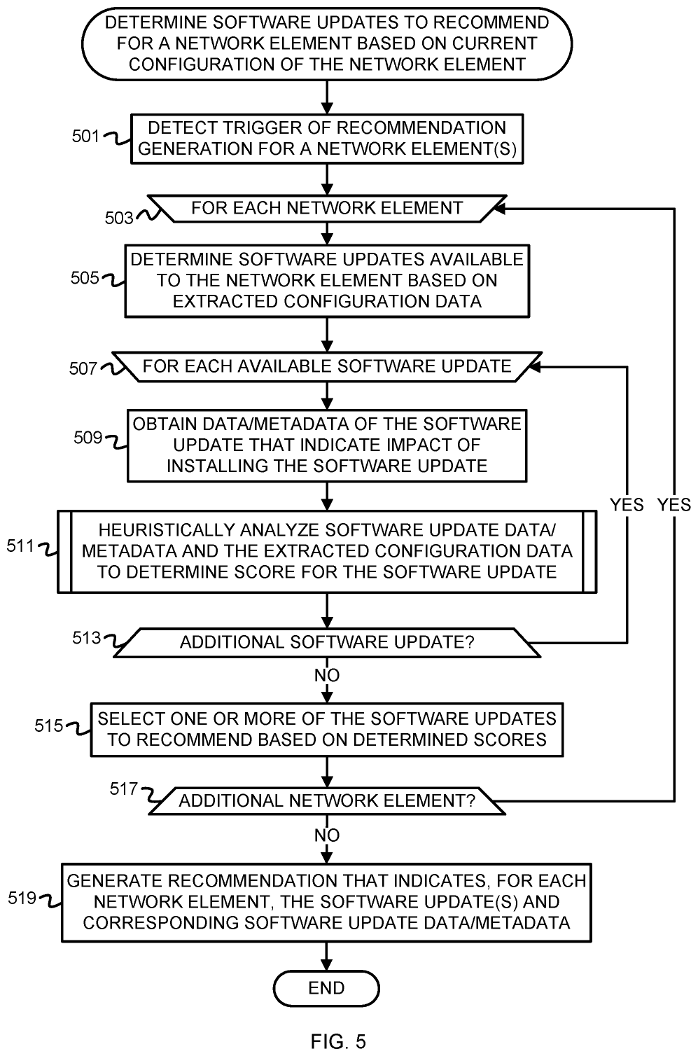

FIG. 5 is a flowchart of example operations for determining one or more software updates to recommend for a network element based on its current configuration. The example operations are described with reference to the recommendation service.

At block 501, the recommendation service detects a trigger of recommendation generation for one or more network elements. Recommendation of software updates for one or more network elements of a customer can be triggered based on one or more conditions being satisfied. Exemplary triggering conditions include receipt of a request for recommendation generation, passage of a preconfigured length of time since a last software update installation for a network element, etc.

At block 503, the recommendation service begins iterating over network elements for which a recommendation is to be generated. The network elements may have been indicated (e.g., by network element identifier) in the data obtained based on the triggering condition being satisfied.

At block 505, the recommendation service determines software updates that are available to the network element based on configuration data that have been extracted for the network element. The recommendation service can maintain data indicating compatibility of software types and versions among network elements offered by the vendor (e.g., in a compatibility matrix). The recommendation service may download this compatibility data from the vendor and update the compatibility data as new software updates become available. The recommendation service determines a type of the network element (e.g., based on its operating system) and a software version currently running on the network element that are indicated in configuration data extracted for the network element. Based on this information, the recommendation service determines the software updates that are compatible with the network element and that are more recent than the software version currently running on the network element. The one or more software updates that result are referred to as those that are available for the network element. At block 507, the recommendation service begins iterating over software updates that are available for the network element.

At block 509, the recommendation service obtains data/metadata of the software update that indicate impact of installing the software update. Impact of installing the software update can be defined in terms of the new features offered by the software update, changes in behavior associated with existing features provided with the software update, and one or more issues that are associated with the software update. The recommendation service queries a repository that maintains data/metadata of software updates with an indication of the software update (e.g., software type/version) to obtain the corresponding data/metadata.

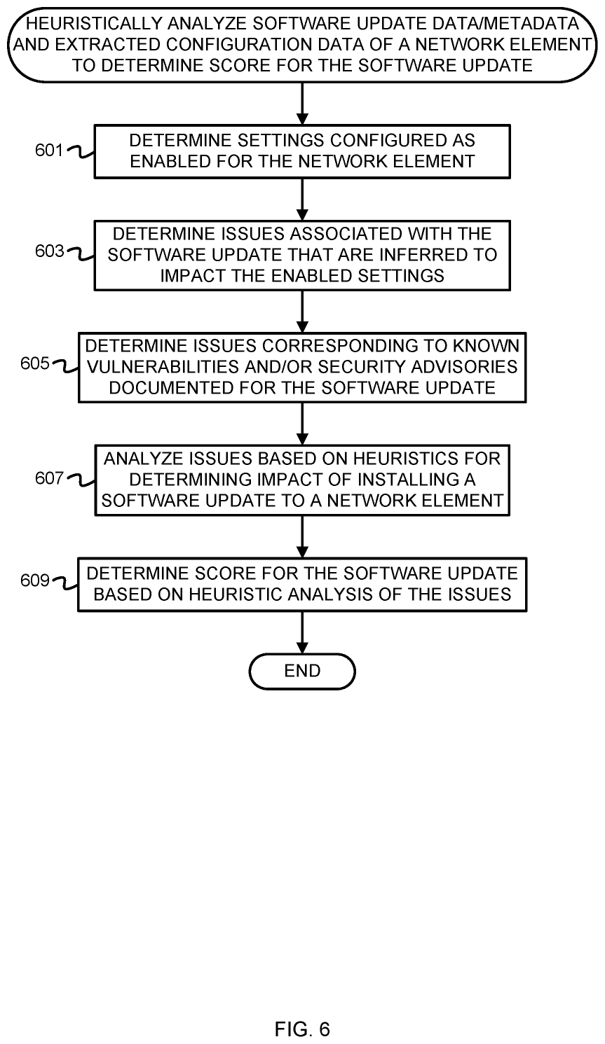

At block 511, the recommendation service heuristically analyzes the data/metadata of the software update and the extracted configuration data to determine a score for the software update. The recommendation service can determine settings of the network element that have been enabled based on the extracted configuration data and correlate the enabled settings with the data/metadata of the update to determine issues indicated in the data/metadata that may impact operation of the network element based on its current configuration. Scoring of the software update can account for the types of issues that are correlated with the network element's enabled settings, frequencies with which those issues are experienced by other customers, and other heuristics for determining the impact of a software update on a network element. Heuristic analysis of data/metadata of a software update and configuration data of a network element to score the software update for the network element is described in further detail in reference to FIG. 6.

At block 513, the recommendation service determines if there is another software update available for the network element. If so, operations continue at block 507. Otherwise, operations continue at block 515.

At block 515, the recommendation service selects one or more of the software updates to recommend based on the determined scores. The recommendation service may select the N software updates with the highest scores, where the value of Nis a preconfigured setting of the service or a parameter value. Selecting a software update can include adding an indication of the software update and the corresponding data/metadata obtained for the software update to a list or other data structure, writing the indication of the software update and corresponding data/metadata to a file, etc.

At block 517, the recommendation service determines if there is another network element for which software updates are to be recommended. If so, operations continue at block 503. Otherwise, operations continue at block 519.

At block 519, the recommendation service generates a recommendation that indicates, for each network element, the recommended software update(s) and corresponding data/metadata of each software update. The recommendation thus indicates each recommended software update and the corresponding impact of installing the software update to the network element in terms of the new features that will be available for configuration, existing features that have changed, and any issues affecting the software update that are relevant to the network element. The recommendation service may generate a report comprising the recommendation and display the recommendation (e.g., via a graphical user interface (GUI)) and/or store the report in a repository for subsequent access and presentation.

As part of generating the recommendation, the recommendation service can further determine issues that may be avoided as a result of installation of each recommended software update. Avoided issues associated with a software update may be relative to other recommended software updates and/or relative to prior software updates. For instance, for each recommended software update, the recommendation service can determine one or more issues (e.g., software bugs and/or vulnerabilities) present in a prior release that have been fixed via the software update. Indications of fixes to issues may be indicated in the data/metadata obtained for each of the recommended software updates.

FIG. 6 is a flowchart of example operations for heuristically analyzing data/metadata of a software update based on extracted configuration data of a network element to inform software update recommendations for the network element. The example operations can implement block 511 of FIG. 5.

At block 601, the recommendation service determines configurable settings that are enabled for the network element. The extracted configuration data obtained for the network element indicate a plurality of settings of the network element and how they have been configured for the network element (e.g., enabled or disabled). The recommendation service determines those of the settings that are configured to be enabled for the network element based on values of the corresponding configuration data fields.

At block 603, the recommendation service determines issues associated with the software update that are inferred to impact the enabled settings. The data/metadata of the software update comprise indications of issues associated with the software update and corresponding configurable settings of a network element that are inferred to be affected by the issues based on the correlation of issue descriptions with feature/configuration descriptions as described above. The recommendation service determines at least a subset of those issues that are inferred to affect the settings of the network element that are enabled and are thus relevant to the network element. The recommendation system can determine the subset of issues based on determining those of the issues inferred to affect a configurable setting determined to be enabled for the network element based on its extracted configuration data.

At block 605, the recommendation service determines any issues corresponding to known vulnerabilities and/or security advisories documented for the software update. The recommendation service may further query a repository storing documented vulnerabilities and/or security advisories that have been identified for the software update.

At block 607, the recommendation service analyzes the issues associated with the software update based on heuristics for determining impact of installing a software update to a network element. Heuristic analysis of the issues is guided by the configuration of the network element based on the correlation of configurable settings inferred to be impacted by issues with enabled settings of the network element. The issues associated with the software update include those inferred to impact enabled settings of the network element and any vulnerabilities or other security advisories identified for the software update. The recommendation service has been configured with heuristics for evaluating impact of installing a software update to a network element based on various aspects of issues associated with the software update, including issue severities and/or frequencies. The heuristics can be implemented with one or more rules and/or thresholds based on which metadata of the issues are evaluated (i.e., determined severities and/or frequencies associated with the issues).

Issue severity can be defined in terms of whether the issue is a documented vulnerability or has otherwise been identified in a security advisory, which may be considered to be of higher severity, or whether the issue is a lower-impact software bug, which may be considered to be of lower severity. Types of each issue associated with the software update can inform severity. The recommendation system may determine an aggregate severity of issues associated with the network element based on the issue types based on the heuristics. For instance, the recommendation system can initialize a default severity level that is adjusted (e.g., increased) based on analysis of severities of issues associated with the software update, where lower severity issues yield a relatively lower adjustment than higher severity issues.

Frequencies of issues can be defined in terms of counts of support tickets or other documented cases from customers reporting that the issue has been experienced. Such case counts of an issue may have been previously associated with the issues inferred to impact the enabled settings. Heuristics for analyzing issue frequencies can indicate that more frequently reported issues should be prioritized in determining impact of installing a software update. To illustrate, if 50 issues are associated with the software update, 30 of those issues are inferred to affect features enabled for the network element, and 25 of those are further reported with a frequency exceeding a threshold (e.g., based on raw counts of reports in support tickets, based on reports in support tickets relative to total numbers of reported issues, etc.), those 25 issues may be accounted for as higher priority, with the remaining 5 being lower priority. Priority of issues can be represented with weights, for instance.

At block 609, the recommendation system determines a score for the software update based on the heuristic analysis of the issues. The recommendation system can compute the score based on results of the heuristic analysis. For instance, the heuristic analysis may yield a plurality of values indicating a severity level of issues associated with the software update, frequency with which issues have been reported for the software update (e.g., based on aggregate count(s) of high priority and/or low priority issues). The score may be further informed based on metadata of the software update, such as based on adoption rate (i.e., number of customer installations), release stability/maturity, etc. For instance, a score may be improved (e.g., based on weighting) if it has a number of reported installations that exceeds a threshold, falls into a designated range, etc., where different weights may correspond to different thresholds/ranges. The recommendation system may compute a heuristic score for the software update based on the values determined from the heuristic analysis, such as based on a formula.

### Variations

The flowcharts are provided to aid in understanding the illustrations and are not to be used to limit scope of the claims. The flowcharts depict example operations that can vary within the scope of the claims. Additional operations may be performed; fewer operations may be performed; the operations may be performed in parallel; and the operations may be performed in a different order. It will be understood that each block of the flowchart illustrations and/or block diagrams, and combinations of blocks in the flowchart illustrations and/or block diagrams, can be implemented by program code. The program code may be provided to a processor of a general purpose computer, special purpose computer, or other programmable machine or apparatus.

As will be appreciated, aspects of the disclosure may be embodied as a system, method or program code/instructions stored in one or more machine-readable media. Accordingly, aspects may take the form of hardware, software (including firmware, resident software, micro-code, etc.), or a combination of software and hardware aspects that may all generally be referred to herein as a “circuit,” “module” or “system.” The functionality presented as individual modules/units in the example illustrations can be organized differently in accordance with any one of platform (operating system and/or hardware), application ecosystem, interfaces, programmer preferences, programming language, administrator preferences, etc.

Any combination of one or more machine readable medium(s) may be utilized. The machine readable medium may be a machine readable signal medium or a machine readable storage medium. A machine readable storage medium may be, for example, but not limited to, a system, apparatus, or device, that employs any one of or combination of electronic, magnetic, optical, electromagnetic, infrared, or semiconductor technology to store program code. More specific examples (a non-exhaustive list) of the machine readable storage medium would include the following: a portable computer diskette, a hard disk, a random access memory (RAM), a read-only memory (ROM), an erasable programmable read-only memory (EPROM or Flash memory), a portable compact disc read-only memory (CD-ROM), an optical storage device, a magnetic storage device, or any suitable combination of the foregoing. In the context of this document, a machine readable storage medium may be any tangible medium that can contain, or store a program for use by or in connection with an instruction execution system, apparatus, or device. A machine readable storage medium is not a machine readable signal medium.

A machine readable signal medium may include a propagated data signal with machine readable program code embodied therein, for example, in baseband or as part of a carrier wave. Such a propagated signal may take any of a variety of forms, including, but not limited to, electro-magnetic, optical, or any suitable combination thereof. A machine readable signal medium may be any machine readable medium that is not a machine readable storage medium and that can communicate, propagate, or transport a program for use by or in connection with an instruction execution system, apparatus, or device.

Program code embodied on a machine readable medium may be transmitted using any appropriate medium, including but not limited to wireless, wireline, optical fiber cable, RF, etc., or any suitable combination of the foregoing.

The program code/instructions may also be stored in a machine readable medium that can direct a machine to function in a particular manner, such that the instructions stored in the machine readable medium produce an article of manufacture including instructions which implement the function/act specified in the flowchart and/or block diagram block or blocks.

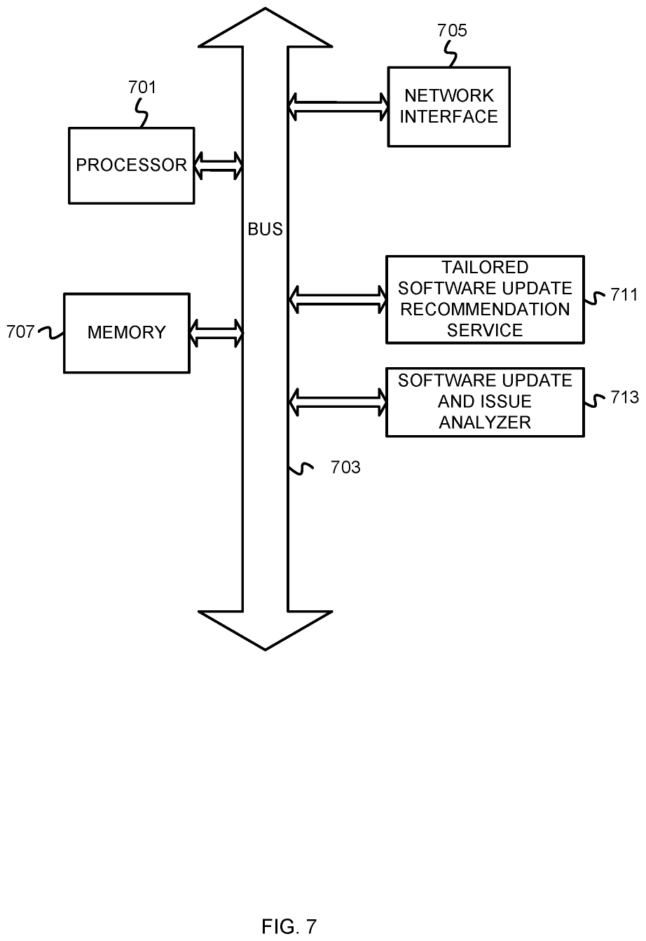

FIG. 7 depicts an example computer system with a tailored software update recommendation service and a software update and issue analyzer. The computer system includes a processor 701 (possibly including multiple processors, multiple cores, multiple nodes, and/or implementing multi-threading, etc.). The computer system includes memory 707. The memory 707 may be system memory or any one or more of the above already described possible realizations of machine-readable media. The computer system also includes a bus 703 and a network interface 705. The system also includes tailored software update recommendation service 711 and software update and issue analyzer 713. The tailored software update recommendation service 711 recommends software updates for network elements based on data and metadata of the software updates determined to be pertinent to the network elements. The software update and issue analyzer 713 generates the data and metadata of software updates based on published documentation and documented issues (e.g., software bugs) associated with the software updates. Any one of the previously described functionalities may be partially (or entirely) implemented in hardware and/or on the processor 701. For example, the functionality may be implemented with an application specific integrated circuit, in logic implemented in the processor 701, in a co-processor on a peripheral device or card, etc. Further, realizations may include fewer or additional components not illustrated in FIG. 7 (e.g., video cards, audio cards, additional network interfaces, peripheral devices, etc.). The processor 701 and the network interface 705 are coupled to the bus 703. Although illustrated as being coupled to the bus 703, the memory 707 may be coupled to the processor 701.

1. A method comprising:
extracting a subset of configuration data obtained for a first network element based on indications of a plurality of features affected by a plurality of software updates;
determining a set of the plurality of software updates that is available for the first network element based on a type of the first network element indicated in the subset of configuration data;
based on analyzing the subset of configuration data and indications of impact of installing each of the set of software updates based on a plurality of heuristics, determining one or more software updates in the set of software updates to recommend for the first network element, wherein the indications of impact of installing each of the set of software updates comprise at least one of the indications of the plurality of features and indications of a plurality of issues that potentially affect the set of software updates; and
generating a recommendation that indicates the one or more software updates and corresponding ones of the indications of impact.

2. The method of claim 1, further comprising generating the indications of the plurality of features based on published documentation associated with each of the plurality of software updates.

3. The method of claim 2, wherein generating the indications of the plurality of features comprises, for each software update of the plurality of software updates,
determining one or more features affected by the software update based on at least one of the published documentation and the indications of the plurality of issues,
wherein the one or more features comprise at least one of one or more features associated with a change in behavior documented in the published documentation and one or more features potentially affected by corresponding ones of the plurality of issues; and
determining, for each of the one or more features, a configuration data field that corresponds to the feature.

4. The method of claim 3, wherein determining the one or more features comprises analyzing descriptions of features in the published documentation and descriptions of the plurality of issues with natural language processing to determine similarities between the descriptions of the features and the descriptions of the plurality of issues and determining that a first feature of the one or more features is potentially affected by a first issue of the plurality of issues based on a determined similarity between a description of the first feature and a description of the first issue.

5. The method of claim 1, wherein the plurality of heuristics comprises heuristics for determining impact of installing a software update to a network element based on features enabled for the network element and issues that potentially affect the software update based on at least one of types of the issues, severity of the issues, likelihood of the issues, and counts of the issues.

6. The method of claim 1, wherein analyzing the subset of configuration data and the indications of impact based on the plurality of heuristics comprises,
determining, based on the subset of configuration data, a set of one or more enabled features of the first network element;
determining, based on the indications of the plurality of issues and the set of enabled features, sets of one or more the plurality of issues that potentially affect at least a subset of the set of enabled features; and
analyzing the sets of issues based on the plurality of heuristics.

7. The method of claim 6, wherein the indications of the plurality of issues comprise an indication of a first software bug associated with a first software update of the set of software updates that potentially affects a first feature of the first network element, wherein determining the sets of issues comprises determining based on the set of enabled features that the first feature is enabled for the first network element, wherein the one of the sets of issues corresponding to the first software update comprises the first software bug.

8. The method of claim 6 further comprising scoring each of the set of software updates based on analyzing the sets of issues, wherein scoring each of the plurality of software updates comprises, for each software update of the set of software updates, determining a score indicating impact of installing the software update based on the corresponding one of the sets of issues, wherein determining the one or more software updates to recommend for the first network element is based on scores determined for the set of software updates.

9. The method of claim 1, wherein the plurality of issues that potentially affect each software update in the set of software updates comprise at least one of one or more software bugs that potentially affect the software update, one or more vulnerabilities, and one or more issues reported in customer support tickets.

10. The method of claim 1, further comprising determining, for at least a first software update of the one or more software updates, one or more issues that would be avoided based on installation of the first software update, wherein the recommendation also indicates the one or more issues that would be avoided.

11. One or more non-transitory machine-readable media having program code stored thereon, the program code comprising instructions to:
determine a set of software updates that are available for a first network element based on a subset of configuration data of the first appliance;
analyze the subset of configuration data and at least one of data and metadata of the set of software updates based on heuristics for determining impact of installing a software update, wherein the at least one of the data and metadata of the set of software updates comprise, for each software update in the set of software updates, at least one of indications of a plurality of features of the first network element that are affected by the software update and indications of a plurality of issues associated with the software update;
select one or more of the set of software updates to recommend based on the analysis; and
generate a recommendation that indicates the one or more software updates and corresponding ones of the at least one of data and metadata.

12. The non-transitory computer-readable media of claim 11, wherein the program code further comprises instructions to generate the at least one of the data and metadata of the set of software updates based on documentation published for each of the set of software updates.

13. The non-transitory computer-readable media of claim 11, wherein the instructions to analyze the at least one of the data and metadata of the set of software updates and the subset of configuration data based on the heuristics comprise instructions to,
determine, based on the subset of configuration data, a set of the plurality of features of the first network element that are enabled for the first network element; and
for each of the set of software updates, determine, based on the indications of the plurality of issues and the set of features enabled for the first network element, that one or more of the plurality of issues potentially affect a corresponding one or more of the set of features and analyze the one or more issues based on the heuristics.

14. The non-transitory computer-readable media of claim 13, wherein the indications of the plurality of issues comprise an indication of a first software bug that potentially affects a feature of the first network element, wherein the instructions to determine the one or more issues comprise instructions to determine based on the set of features that the feature is enabled for the first network element, and wherein the one or more issues comprise the first software bug.

15. The non-transitory computer-readable media of claim 11, wherein the program code further comprises instructions to determine, for each software update in the set of software updates, a score indicating impact of installing the software update based on analysis of corresponding ones of the at least one of the data and metadata and the subset of configuration data, wherein the instructions to select the one or more software updates to recommend comprise instructions to select the one or more software updates based on scores determined for the set of software updates.

16. An apparatus comprising:
a processor; and
a machine-readable medium having instructions stored thereon that are executable by the processor to cause the apparatus to,
extract, from configuration data obtained for a first network element, a subset of the configuration data based on indications of a plurality of configuration settings affected by a plurality of software updates;
determine a set of the plurality of software updates that is available for the first network element based on the subset of the configuration data;
analyze the subset of the configuration data and at least one of data and metadata of the set of software updates based on a plurality of heuristics, wherein the at least one of data and metadata of the set of software updates comprise at least one of the indications of the plurality of configuration settings and indications of a plurality of issues potentially associated with the set of software updates;
determine one or more of the set of software updates to recommend based on the analysis; and
indicate the one or more software updates and corresponding ones of the at least one of data and metadata of the set of software updates.

17. The apparatus of claim 16, further comprising instructions executable by the processor to cause the apparatus to generate the indications of the plurality of configuration settings affected by the plurality of software updates based on published documentation of the plurality of software updates, wherein the instructions executable by the processor to cause the apparatus to generate the indications of the plurality of configuration settings comprise instructions executable by the processor to cause the apparatus to,
determine one or more features affected by the software update based on at least one of the published documentation and the indications of the plurality of issues; and
determine, for each of the one or more features, a configuration data field that corresponds to the feature.

18. The apparatus of claim 16, wherein the plurality of heuristics comprises heuristics for determining impact of installing software updates, wherein the instructions executable by the processor to cause the apparatus to analyze the subset of the configuration data and the at least one of the data and metadata of the set of software updates based on the plurality of heuristics comprise instructions executable by the processor to cause the apparatus to,
determine, based on the subset of the configuration data, one or more settings of the first network element that have been enabled; and
for each software update in the set of software updates and corresponding issues indicated in the indications of the plurality of issues, determine one or more of the issues that are relevant to the first network element based on the one or more issues potentially affecting corresponding ones of the one or more settings and analyze the one or more issues based on the heuristics.

19. The apparatus of claim 18, wherein the indications of the plurality of issues comprise an indication of a first software bug that potentially affects a first feature of the first network element, wherein the instructions executable by the processor to cause the apparatus to determine the one or more issues that are relevant to the first network element comprise instructions executable by the processor to cause the apparatus to determine that the first feature is enabled for the first network element based on the determined one or more settings of the first network element.

20. The apparatus of claim 16 further comprising instructions executable by the processor to cause the apparatus to score each of the set of software updates based on the analysis, wherein the instructions executable by the processor to cause the apparatus to score each of the plurality of software updates comprise instructions executable by the processor to cause the apparatus to, for each software update of the set of software updates, determine a score indicating impact of installing the software update on the first network element, wherein determination of the one or more software updates to recommend for the first network element is based on scores determined for the set of software updates.
